(19) United States
(12) Patent Application Publication
(10) Pub. No.: US 2016/0078389 A1
(43) Pub. Date: Mar. 17, 2016

(54) CUSTOMER SATISFACTION-BASED RATINGS

(71) Applicant: Empire technology Development LLC, Wilmington, DE (US)

(72) Inventor: Seungil KIM, Seoul (KR)

(21) Appl. No.: 14/430,757

(22) PCT Filed: Sep. 12, 2014
(86) PCT No.: PCT/US14/55403

§ 371 Date: Mar. 24, 2015

(51) Int. Cl. G06Q 10/06; G06Q 50/12

(52) U.S. Cl. CPC G06Q 10/06398; G06Q 50/12

(57) ABSTRACT

In some examples, a customer satisfaction-based rating may be produced by receiving transaction information corresponding to at least one payment made to a place of business. For each transaction, a total amount of the payment made to the place of business may be determined and an amount tipped may be extracted from the total amount of the payment made to the place of business, and a tip ratio based on the extracted amount tipped and the total amount of the payment made to the place of business may be calculated. An average tip ratio may be calculated based on the calculated tip ratio, and then used as a factor in determining a customer satisfaction-based rating for the place of business.

### TECHNICAL FIELD

The described technology pertains generally to customer satisfaction-based ratings based on transaction information.

### BACKGROUND

Unless otherwise indicated herein, the approaches described in this section are not prior art to the claims in this application and are not admitted to be prior art by inclusion in this section.

The Internet is replete with websites and client-based applications that provide forums for customers to voice either their satisfaction or displeasure with various businesses. These forums allow users to rate their transactional experiences, whether it be an item purchase, a hotel stay, a meal, an experience, etc. The individual ratings submitted to and provided on the various forums are subjective, typically based on one or more personal criterion. For example, some restaurant patrons may base their posted satisfaction rating for a restaurant based on the quality of their food while other patrons of the same restaurant may base their posted satisfaction rating based on the attentiveness of the wait staff. Further, the online forums may present the subjective ratings using various and/or intermixed formats. For example, some online forums or client-based applications may allow users to comment on the quality of their transactional experiences by, e.g., filling out an on-line form or interacting with an application interface to leave a subjective quality ranking, e.g., a rating on a scale of 1-10 or a rating of zero to five stars.

### SUMMARY

In one example embodiment, a customer satisfaction-based rating method may include receiving transaction information from a place of business, the transaction information corresponding to at least one payment made to the place of business, and each payment corresponding to a transaction. The method may further include, for each transaction: determining, from the received transaction information, a total amount of the payment made to the place of business; extracting, from the total amount of the payment made to the place of business, an amount tipped; and calculating a tip ratio based on the extracted amount tipped and the total amount of the payment made to the place of business. The method may further include calculating an average tip ratio based on the calculated tip ratio, the average tip ratio to be used as a factor in determining a customer satisfaction-based rating for the place of business.

In another embodiment, a service provider may include: a receiver that is configured to receive transaction information corresponding to at least one payment made by a customer to a place of business, each payment corresponding to a transaction; a tip calculator that is configured to calculate, for each transaction, tip data based on the payment made; and a ratings processor that is configured to determine a customer satisfaction-based rating for the place of business based on the calculated tip data.

In yet another example embodiment, a non-transitory computer-readable medium may store executable instructions that, when executed, cause one or more processors to: receive a receipt regarding a payment made to a place of business, calculate tip data based on the payment made to the place of business, categorize the calculated tip data, and socialize the categorized tip data as a customer satisfaction-based rating for the place of business.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which customer satisfaction-based ratings may be implemented, arranged in accordance with at least some embodiments described herein;

FIG. 2 shows an example configuration of a service provider by which at least portions of customer satisfaction-based ratings may be implemented, arranged in accordance with at least some embodiments described herein;

FIG. 3 shows an example processing flow by which at least portions of customer satisfaction-based ratings may be implemented, arranged in accordance with at least some embodiments described herein;

FIG. 4 shows another example processing flow by which at least portions of satisfaction-based ratings may be implemented, arranged in accordance with at least some embodiments described herein;

FIG. 5 shows an example ratings interface produced in accordance with at least some embodiments of customer satisfaction-based ratings described herein; and

FIG. 6 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Embodiments described and implied herein relate to customer satisfaction-based ratings for places of business based on transaction information. Online and application-based forums allow users to rate their transactional experiences with places of business. In accordance with some embodiments described herein, customer satisfaction-based ratings for a place of business may be generated based on indications of the business' customers' satisfaction represented by tips, or gratuities, paid or given by the customers while transacting at the place of business. Non-limiting examples of places of business include merchants, service providers, and the like. In some transactions, the customer may make a payment directly to the place of business, e.g., pay for the transaction in cash; in other transactions, the customer may make a payment to a financial institution, e.g., a credit card company, which in turn provides the payment to the place of business e.g., pay for the transaction using a credit or debit card. The embodiments of customer satisfaction-based ratings described herein may be implemented for both types of transactions.

As referenced herein, transaction information may refer to money paid by one or more customers while conducting a respective purchase or transaction of, by way of example, one or more items, services, and/or experiences. The transaction information may include an amount of money that is rightfully owed for the transaction, e.g., actual price, as well as a tip.

Further, the transaction information for the respective purchases or transactions may include additional information that may be used to categorize a customer satisfaction-based rating. Non-limiting examples of categories by which a customer satisfaction-based rating may be categorized include a time of day for the transaction; a description of the item, service, and/or experience that is the subject of the transaction, e.g., time of day, type of meal (breakfast, lunch, brunch, or dinner), a name of particular wait staff or attendant; a number of transactions by a particular customer or patron; etc. The format of the additional information, and descriptors thereof, that may be used to categorize a customer satisfaction-based rating are myriad.

The transaction information corresponding to an individual purchase may be procured in the form of a receipt or invoice, and may be provided to a service provider in electronic form. Alternatively, the transaction information corresponding to an individual purchase may be provided to a service provider in a format that provides a measure of anonymity for the customer or patron that a receipt or invoice does not. For example, the format of the transaction information may include, at least, an amount owed and an amount paid for a respective transaction without including the customer's name or portions of the customer's credit card number, which would likely be included in a receipt or invoice.

Regardless of the form of conveyance, the transaction information may be read and recorded using a server hosted by or corresponding to a service provider using known technologies for data compilation.

As further referenced herein, a tip may refer to an amount of money, given voluntarily beyond the amount rightfully owed for the transaction. An amount tipped for a respective transaction may often be given to signify a customer's level of satisfaction with regard to the respective transaction. A tip may also be referred to as a gratuity, and the two terms may be used interchangeably herein.

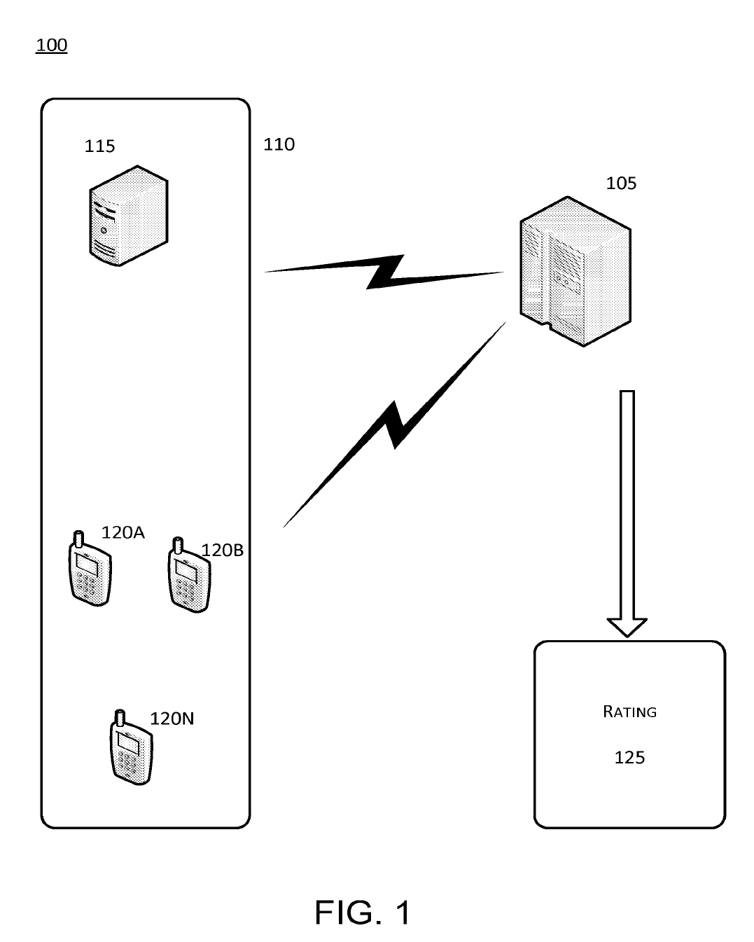

FIG. 1 shows an example system configuration 100 in which customer satisfaction-based ratings may be implemented, arranged in accordance with at least some embodiments described herein. System configuration 100 may include a service provider 105, which may provide, among other services, customer satisfaction-based ratings; and system configuration 100 may also include at least one place of business 110. A server 115 may be located at place of business 110 or may be remotely located away from place of business 110. Regardless of location, server 115 may provide transaction information regarding respective transactions for an item, service or experience provided by place of business 110, to service provider 105. Client devices 120A, 120B, . . . , 120N may be respectively owned and/or operated by current or past customers or patrons of place of business 110. Unless context requires otherwise, singular reference may be made to client device 120 and/or collective reference may be made to client devices 120. Further, embodiments of customer satisfaction-based ratings are in no way limited to a set number of client devices 120. Respective ones of client devices 120 may also provide transaction information regarding respective transactions for an item, service or experience provided by place of business 110, to service provider 105. Based on the received transaction information, service provider 105 may produce a customer rating 125 and socialize the produced customer rating 125 via the online forum and/or client-based application, as disclosed herein.

Service provider 105 may refer to an entity, having an online presence via website and/or client-based application, capable of receiving and/or accessing transaction information pertaining to at least place of business 110. Service provider 105 may be a financial institution that manages credit card accounts, debit card accounts, and/or pay-by-phone accounts for its customers who patronize place of business 110, among other places of business. However, implementations of service provider 105 are in no way limited to financial institutions. Service provider 105 may also be an online review site or application host including, but not limited to, e.g., Yelp®, Angie's List®, Epions®, TripAdvisor®, etc.

Service provider 105 may include one or more server computers that are configured, programmed, and/or designed to produce a customer satisfaction-based rating based on transaction information for one or more transactions with regard to place of business 110. For such purposes, service provider 105 may be configured, programmed, and/or designed to receive transaction information corresponding to at least one payment made by one or more customers or patrons to place of business 110, each payment corresponding to a transaction; calculate, for each transaction, tip data based on the payment made for the respective transactions; and determine a customer satisfaction-based rating for place of business 110 based on the calculated tip data. The calculated tip data for a respective transaction may itself serve as a customer satisfaction-based rating for place of business 110 based on the transaction.

However, the customer satisfaction-based rating may also be determined as a relative measure. As an example, the calculated tip data for an individual customer for a transaction with place of business 110 may be ranked relative to the calculated tip data for the same customer (1) for previous transactions with place of business 110 or (2) for one or more transactions with other places of business. Alternatively, the calculated tip data for the individual customer for a transaction with place of business 110 may be ranked relative to the calculated tip data for transactions for one or more other customers for place of business 110.

Place of business 110 may refer to a business establishment or service provider for whom transactions typically involve the payment of tips/gratuities by customers or patrons. Non-limiting examples of a business establishment as place of business 110 may include a restaurant, a hotel, or a coffee shop. Non-limiting examples of a service provider as place of business 110 may include a valet parking service, a cleaning service, a laundromat/drycleaner, etc. Further, place of business 110 may refer to a business establishment or service provider for whom referrals may be helpful to gain new customers or to retain customers. Thus, place of business 110 may a subject of customer satisfaction-based ratings in an online forum or a client-based application.

As referenced above, non-limiting examples of categories by which a customer satisfaction-based rating may be categorized include a time of day for the transaction; a description of the item, service, and/or experience that is the subject of the transaction, e.g., time of day, type of meal (breakfast, lunch, brunch, or dinner), a name of particular wait staff or attendant; a number of transactions by a particular customer or patron; etc. Categorization of customer satisfaction-based ratings may be performed based on information that is included in transaction information provided to service provider 105 with regard to a respective transaction for place of business 110. Factors that may influence a customer satisfaction-based rating for a respective transaction for place of business 110 may include, but not be limited to, quality of service by one or more of a wait staff attendant, a barista, a maitre d′, a bell staff member, a concierge, a doorman, a valet parking attendant, a delivery person, etc. These non-limiting examples of such factors may also be listed or identified in the transaction information provided to service provider 105.

Transaction information regarding place of business 110 and one or more of its customers or patrons, may be provided to service provider 105 that may, in turn, generate a customer satisfaction-based rating for place of business 110 based at least on the received transaction information. The transaction information may be provided to service provider 105 from one or more servers associated with place of business 110 or from one of client devices 120. As referenced herein, providing transaction information to service provider 105 may include transmissions implemented utilizing a wired or wireless communication protocol. Non-limiting examples of such a wireless network communication protocol may include a mobile radio communication network including at least one of a 3^{rd} generation (3G), 4^{th} generation (4G), or 5th generation (5G) mobile telecommunications network, various other mobile telecommunications networks, a satellite network, WiBro (Wireless Broadband Internet), Mobile WiMAX (World Interoperability for Microwave Access), HSDPA (High Speed Downlink Packet Access), etc. Further, in order to protect the privacy of a customer or patron's financial information that may be included in the transaction information, the transaction information may be provided to service provider 105, by any of the protocols described above, in encrypted form.

Server 115 may represent one or more server computers that may be configured, programmed, and/or designed to provide transaction information corresponding to at least one payment made to place of business 110 to service provider 105, each payment corresponding to a transaction. In some embodiments, server 115 may be physically located at place of business 110. In other embodiments, server 115 may be remotely located.

Client devices 120 may be configured, programmed, and/or designed to provide transaction information corresponding to at least one payment made to service provider 105. In accordance with some embodiments, one of client devices 120 may provide the transaction information to service provider 105 while located on or near the premises of place of business 110. However, by other embodiments, one of client devices 120 may provide the transaction information to service provider 105 from locations other than the premises of place of business 110. For example, a past customer or patron of place of business 110 may provide transaction information from, e.g., client device 120A to service provider 105 several hours or even several days after completing a transaction with place of business 110.

Client devices 120 may respectively refer to a smart phone, a tablet computer, a notebook computer, a personal computer, or other personal communication device that may provide transaction information to service provider 105 using wired or wireless communication protocols, including those referenced above. In accordance with the embodiments described herein, each of client devices 120 may be assumed to be at least operated by a person who has authorized or otherwise consented to having personal financial information provided to service provider 105 from the respective client device. According to the embodiments described herein, an operator of client device 120 may be a customer or patron of service provider 105. Further, by some of the embodiments, an operator of client device 120 may be a subscriber to a customer rating service provided by service provider 105.

Rating 125 may refer to a customer satisfaction-based rating for place of business 110 that is generated by service provider 105 based on, at least, transaction information received from server 115 or one of client devices 120. Rating 125 may be displayed on a web-page of an online customer ratings service on a client-based application hosted by service provider 105. The actual display of the individual and/or collective customer satisfaction-based ratings may take many forms, as evidenced by the diversity of design shown by e.g., Yelp®, Angie's List®, Epions®, TripAdvisor®, etc., and therefore the embodiments of customer satisfaction-based ratings are not limited to any particular design or layout.

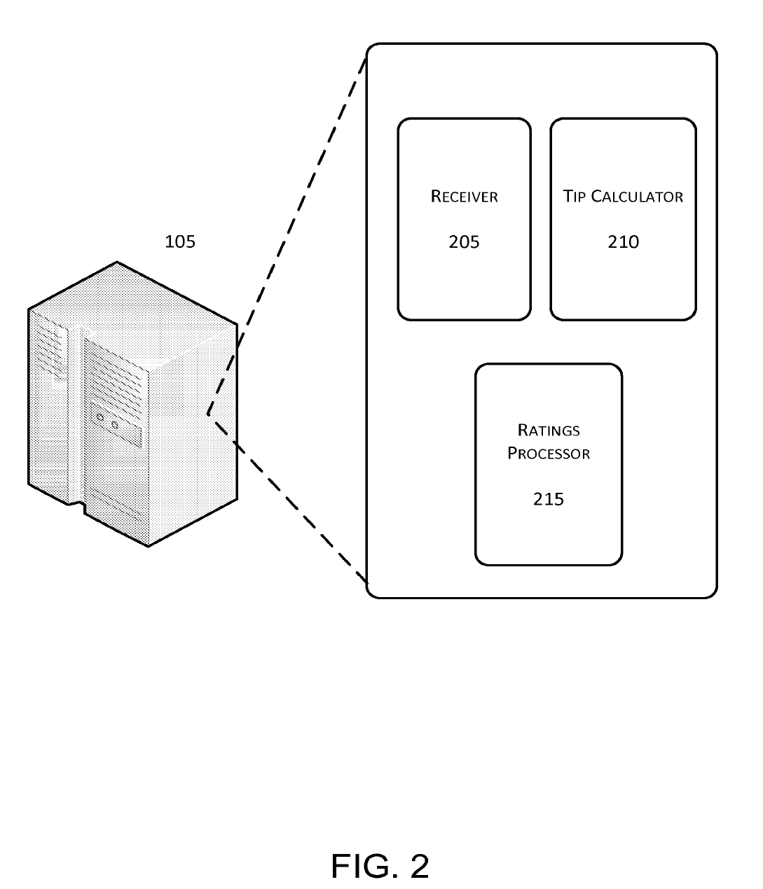

FIG. 2 shows an example configuration of service provider 105 by which at least portions of customer satisfaction-based ratings may be implemented, arranged in accordance with at least some embodiments described herein. As depicted, service provider 105 may include various components such as receiver 205, tip calculator 210, and ratings processor 215. Although illustrated as discrete components, various components of service provider 105 may be divided into additional components, combined into fewer components, or eliminated altogether while being contemplated within the scope of the disclosed subject matter. It will be understood that each function and/or operation of the components may be implemented, individually and/or collectively, by a wide range of hardware, software, firmware, or any combination thereof. In that regard, one or more of receiver 205, tip calculator 210, and ratings processor 215 may be included in a program or application hosted and executable on a server hosted on or otherwise associated with service provider 105.

Receiver 205 may refer to a component or module that is configured, programmed, and/or designed to receive transaction information corresponding to at least one payment made by a customer to place of business 110, each payment corresponding to a transaction. Accordingly, receiver 205 may be implemented by hardware, software, firmware, or any combination thereof, to receive transmitted transaction information from one or more of server 115 or client devices 120.

Further, the transaction information received by receiver 205 may include a currency amount that is rightfully owed for a transaction, i.e., the actual price of the item, service, and/or experience, to place of business 110. The received transaction information for the transaction may further include a tip paid by the customer or patron, beyond the actual price, to place of business 110. The transaction information for the transaction may also include information that may be used to categorize a customer satisfaction-based rating including, but not limited to, a time of day for the transaction; a description of the item, service, and/or experience that is the subject of the transaction, e.g., time of day, type of meal (breakfast, lunch, brunch, or dinner), a name of particular wait staff or attendant; a number of transactions by a particular customer or patron; etc. The transaction information corresponding to a transaction may be provided to receiver 205 as a receipt or invoice in an electronic or digital format. Thus, the transaction information may be read, recorded, and categorized by one or more servers hosted by or corresponding to service provider 105 using known technologies for data compilation.

Tip calculator 210 may refer to a component or module that is configured to calculate tip data based on the payment made for each transaction identified or referenced in the transaction information received by receiver 205.

The tip data may include the tip for the transaction referenced in the received transaction information. Tip calculator 210 may calculate the tip by subtracting the amount authorized for payment for the transaction from the total amount of payment made to place of business 110.

The tip data calculated by tip calculator 210 may also include a tip ratio and an average tip ratio. The calculated tip ratio and average tip ratio may be used individually or collectively to determine a customer satisfaction-based rating for place of business 110. Tip calculator 210 may calculate the tip ratio for each transaction that is referenced in the received transaction information, as follows:

the tip ratio=(the amount tipped÷the total amount of the payment)×100.

Tip calculator 210 may further calculate the average tip ratio for at least one transaction, as follows:

the average tip ratio=(1/N)Σ^{N}ₙ₌₁ tip ratio, with n being an index register for each transaction.

The average tip ratio may be calculated for each transaction. As alternatives, the average tip ratio may be continuously calculated to account for each successive transaction, or the average tip ratio may be calculated at various time intervals or at predetermined time periods, e.g., monthly.

Thus, tip calculator 210 may be configured, programmed, and/or designed to produce tip-related data that may be used as indicators of customer or patron satisfaction with place of business 110.

An average personalized tip ratio may also be calculated for a particular customer. As described above, a tip may refer to an amount of money given voluntarily beyond the amount rightfully owed for the transaction. An amount tipped for a respective transaction may often be given to signify a customer's level of satisfaction with regard to the respective transaction. While a tip of 15-20% beyond the amount rightfully owed to the place of business may be viewed as being obligatory according to some social mores or even business practices, such amounts are not mandated. Thus, an amount tipped for a respective transaction may often be given to signify a customer's level of satisfaction with regard to the respective transaction, since individual customers may have their own tipping tendencies. Some customers may tend to give generous tips, e.g., 18-20%, while other customers may tend to give smaller tips, e.g., 10-15%.

According to at least some embodiments described herein, a customer's level of satisfaction for a respective transaction may be more accurately gleaned if the respective customer's tipping tendencies are eliminated. Therefore, for a particular customer, tip calculator 210 may additionally or alternatively determine an average personalized tip ratio using a recorded history of tip ratios for transactions that involve the particular customer and place of business 110. The calculated average personalized tip ratio may be used to calculate a modified tip index, as follows:

modified tip index=(tip ratio÷average personalized tip ratio).

The particular customer's satisfaction for place of business 110 may be estimated based on a calculation of an average tip index by tip calculator 210, as follows:

average tip index=(1/N)Σ^{N}ₙ₌₁ modified tip indexₙ, with n being an index register for each transaction.

Ratings processor 215 may refer to a component or module that may be configured, programmed, and/or designed to output rating 125 for the place of business based on the calculated tip data. In accordance with the embodiments described herein, customer satisfaction with place of business 110 may be based on tip ratio and/or average tip ratio, with the calculated tip data being presumed to be commensurate with customer satisfaction; additionally, or alternatively, customer satisfaction with place of business 110 may be based on a modified tip index and/or average tip index, with the calculated tip data being presumed to be commensurate with a particular customer's indicated satisfaction. The numerically-based customer satisfaction-based ratings may be presented to one or more users in various graphical formats in an online forum or client-based application.

For example, ratings processor 215 may rank the calculated tip data for an individual customer for a transaction with place of business 110 relative to the calculated tip data for the same customer for previous transactions with place of business 110; or ratings processor 215 may rank the calculated tip data for the individual customer for a transaction with place of business 110 relative to the calculated tip data for one or more transactions with other places of business. Alternatively, ratings processor 215 may rank the calculated tip data for the individual customer for a transaction with place of business 110 relative to the calculated tip data for transactions for one or more other customers for place of business 110.

As indicated previously with regard to the additional information included in the received transaction information, ratings processor 215, singularly or in combination with tip calculator 210, may optionally categorize the calculated tip ratio and/or average tip ratio, based on information received along with the transaction information. Non-limiting examples of the additional information includes, but is not limited to, time of day, type of meal, a name of particular wait staff or attendant; a number of transactions by a particular customer or patron; etc., to produce customer satisfaction-based ratings that project customer or patron satisfaction towards features of place of business 110.

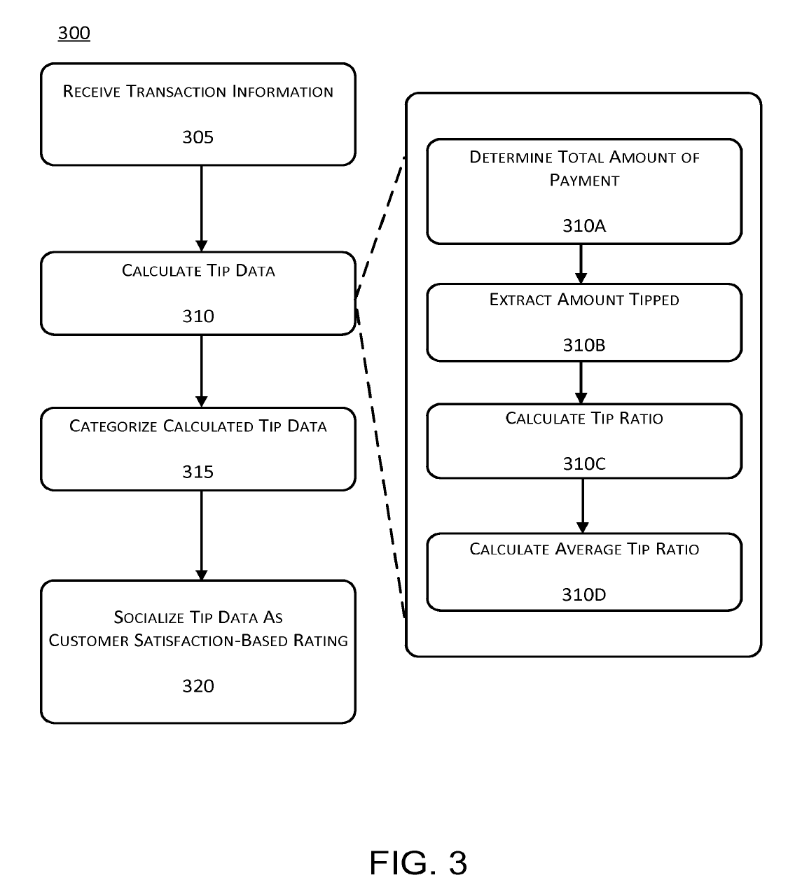

FIG. 3 shows an example processing flow 300 by which at least portions of customer satisfaction-based ratings may be implemented, arranged in accordance with at least some embodiments described herein. Processing flow 300 may be implemented by service provider 105 singularly or in combination with any of server 115 and/or one or more of user client devices 120A, 120B, . . . , 120N. Further, processing flow 300 may include one or more operations, actions, or functions depicted by one or more blocks 305, 310, 315, and 320. Block 310 may include one or more operations, actions, or functions depicted by one or more sub-blocks, 310A, 310B, 310C, and 310D. Although illustrated as discrete blocks, various blocks may be divided into additional blocks, combined into fewer blocks, or even eliminated, depending on the desired implementation. Processing flow 300 may begin at block 305.

Block 305 (Receive Transaction Information) may refer to receiver 205 receiving transaction information corresponding to at least one payment made by a customer to place of business 110, with each payment corresponding to a transaction. The transaction information may be received from one or more of server 115 or client devices 120, and may indicate an amount paid that reflects an actual price of the item, service, and/or experience, to place of business 110 for one or more transactions. The received transaction information for a transaction may also indicate a tip paid by the customer to place of business 110 in conjunction with a transaction. In addition, the transaction information for a transaction may also include information that may be used to categorize a customer satisfaction-based rating. The received transaction information for a transaction may be in the form of a receipt or invoice, and may be transmitted in an electronic or digital format. Thus, the transaction information may be read, recorded, and categorized by a server hosted by or corresponding to service provider 105 using known technologies for data compilation. Block 305 may be followed by block 310.

Block 310 (Calculate Tip Data) may refer to tip calculator 210 calculating tip data based on the payment made for a transaction referenced in the received transaction information. The calculated tip data may include a tip or gratuity paid to place of business 110, tip ratio for the tip paid to place of business 110, an average tip paid to place of business 110, and an average tip ratio for tips paid to place of business 110, all in conjunction with a transaction. Example implementations of block 310 may include tip calculator 210 utilizing the received transaction information as a basis for performing operations, actions, or functions depicted by one or more sub-blocks, 310A, 310B, 310C, and 310D.

Sub-block 310A (Determine Total Amount of Payment) may include tip calculator 210 identifying an actual price for an item, service, and/or experience that is the subject of a transaction; a total payment made to place of business 110 for the transaction; as well as any amount paid above the actual price for the transaction. Sub-block 310A may be followed by sub-block 310B.

Sub-block 310B (Extract Amount Tipped) may include tip calculator 210 subtracting the amount authorized for payment from the total amount of payment made to place of business 110 for the transaction. Sub-block 310B may be followed by sub-block 310C.

Sub-block 310C (Calculate Tip Ratio) may include tip calculator 210 calculating the tip ratio for the transaction, as follows:

the tip ratio=(the amount tipped÷the total amount of the payment)×100.

Sub-block 310C may be followed by sub-block 310D.

Sub-block 310D (Calculate Average Tip Ratio) may include tip calculator 210 calculating the average tip ratio for at least one transaction corresponding to place of business 110, utilizing the calculated tip ratio, as follows:

the average tip ratio=(1/N)Σ^{N}ₙ₌₁ tip ratio, with n being an index register for each transaction.

Block 310 may be followed by block 315.

The average tip ratio may be calculated for each transaction. As alternatives, the average tip ratio may be continuously calculated to account for each successive transaction, or the average tip ratio may be calculated at various time intervals or at predetermined time periods, e.g., monthly.

Block 315 (Categorize Calculated Tip Data) may refer to tip calculator 210 and/or ratings processor 215 optionally categorizing the calculated tip ratio and/or average tip ratio, based on information received along with the transaction information. Again, the information may include, but not be limited to, time of day, type of meal, a name of particular member of the wait staff or an attendant; a number of transactions by a particular customer or patron; etc.

Block 320 (Socialize Tip Data as Customer Satisfaction-Based Rating) may refer to ratings processor 215 generating customer satisfaction-based rating, e.g., rating 125, that indicates customer satisfaction towards place of business 110, which may or may not be categorized. The customer satisfaction with place of business 110 may be based on tip ratio and/or average tip ratio, with the calculated tip data being commensurate with customer or patron satisfaction; and may be output to an online review site or forum or to an application server for presentation to users or subscribers to service provider 105.

Thus, service provider 105 may produce a customer satisfaction-based rating that is based on transaction information.

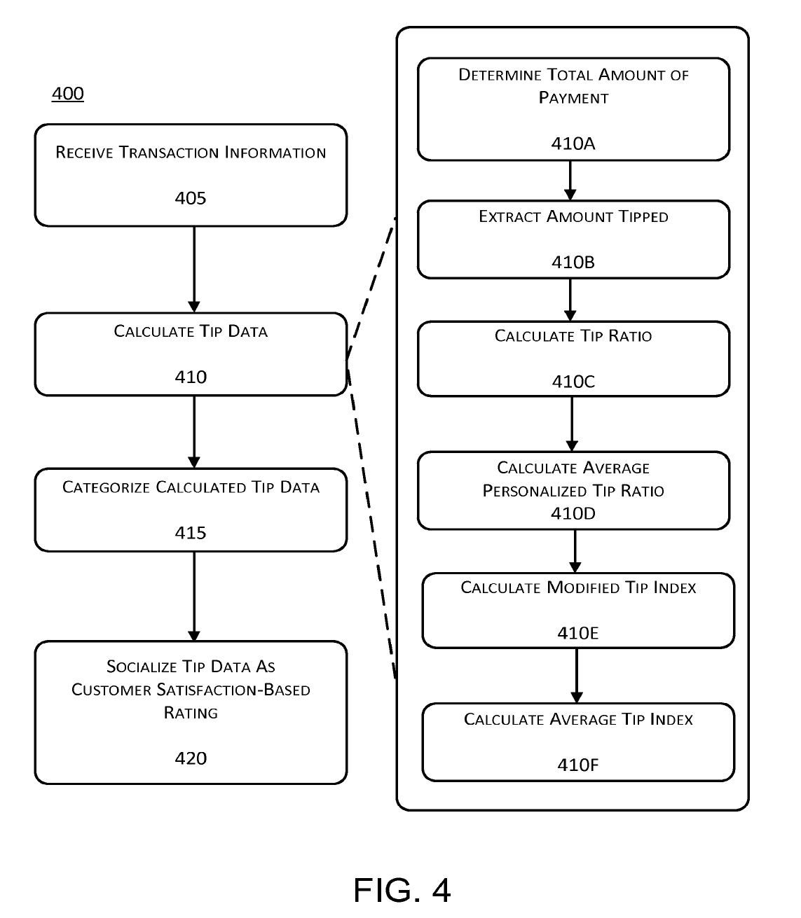

FIG. 4 shows another example processing flow by which at least portions of satisfaction-based ratings may be implemented, arranged in accordance with at least some embodiments described herein. Processing flow 300 may be implemented by service provider 105 singularly or in combination with any of server 115 and/or one or more of user client devices 120A, 120B, . . . , 120N. Further, processing flow 300 may include one or more operations, actions, or functions depicted by one or more blocks 405, 410, 415, and 420. Block 410 may include one or more operations, actions, or functions depicted by one or more sub-blocks 410A, 410B, 410C, 410D, 410E, and 410F. Although illustrated as discrete blocks, various blocks may be divided into additional blocks, combined into fewer blocks, or even eliminated, depending on the desired implementation. Processing flow 400 may begin at block 405.

Block 405 (Receive Transaction Information) may refer to receiver 205 receiving transaction information corresponding to at least one payment made by a customer to place of business 110, with each payment corresponding to a transaction. The transaction information may be received from one or more of server 115 or client devices 120, and may indicate an amount paid that reflects an actual price of the item, service, and/or experience, to place of business 110 for one or more transactions. The received transaction information for a transaction may also indicate a tip paid by the customer to place of business 110 in conjunction with a transaction. In addition, the transaction information for a transaction may also include information that may be used to categorize a customer satisfaction-based rating. The received transaction information for a transaction may be in the form of a receipt or invoice, and may be transmitted in an electronic or digital format. Thus, the transaction information may be read, recorded, and categorized by a server hosted by or corresponding to service provider 105 using known technologies for data compilation. Block 405 may be followed by block 410.

Block 410 (Calculate Tip Data) may refer to tip calculator 210 calculating tip data based on the payment made for a transaction referenced in the received transaction information. The calculated tip data may include a tip or gratuity paid to place of business 110, tip ratio for the tip paid to place of business 110, an average tip paid to place of business 110, and an average tip ratio for tips paid to place of business 110, all in conjunction with a transaction. Example implementations of block 310 may include tip calculator 210 utilizing the received transaction information as a basis for performing operations, actions, or functions depicted by one or more sub-blocks 410A, 410B, 410C, 410D, 410E, and 410F.

As described above, a tip may refer to an amount of money, given voluntarily beyond the amount rightfully owed for the transaction. An amount tipped for a respective transaction may often be given to signify a customer's level of satisfaction with regard to the respective transaction. While a tip of 15-20% beyond the amount rightfully owed to the place of business may be viewed as being obligatory, such amounts are not mandated. Thus, a tip for a respective transaction may often be given to signify a customer's level of satisfaction with regard to the respective transaction.

Sub-block 410A (Determine Total Amount of Payment) may include tip calculator 210 identifying an actual price for an item, service, and/or experience that is the subject of a transaction; a total payment made by the customer to place of business 110 for the transaction; as well as any amount paid above the actual price for the transaction. Sub-block 410A may be followed by sub-block 410B.

Sub-block 410B (Extract Amount Tipped) may include tip calculator 210 subtracting the amount authorized for payment from the total amount of payment made by the customer to place of business 110 for the transaction. Sub-block 410B may be followed by sub-block 410C.

Sub-block 410C (Calculate Tip Ratio) may include tip calculator 210 calculating the tip ratio for the transaction, as follows:

the tip ratio=(the amount tipped÷the total amount of the payment)×100.

Sub-block 410C may be followed by sub-block 410D.

Sub-block 410D (Calculate Average Personalized Tip Ratio) may include tip calculator 210 calculating an average personalized tip ratio using a recorded history of tip ratios, stored by service provider 105, for transactions that involve the particular customer and place of business 110. Sub-block 410D may be followed by sub-block 410E.

Sub-block 410E (Calculate Modified Tip Index) may include tip calculator 210 calculating a modified tip index for the particular customer, as follows:

modified tip index=(tip ratio÷average personalized tip ratio).

Sub-block 410E may be followed by sub-block 410F.

Sub-block 410F (Calculate Average Tip Index) may include tip calculator 210 calculating an average tip index as an indicating of the particular customer's satisfaction for place of business 110, as follows:

average tip index=(1/N)Σ^{N}ₙ₌₁ modified tip indexₙ, with n being an index register for each transaction.

Block 410 may be followed by block 415.

Block 415 (Categorize Calculated Tip Data) may refer to tip calculator 210 and/or ratings processor 215 optionally categorizing the modified tip index and/or average tip index for the particular customer, based on information received along with the transaction information. Again, the information may include, but not be limited to, time of day, type of meal, a name of particular member of the wait staff or an attendant; a number of transactions by a particular customer or patron; etc.

Block 420 (Socialize Tip Data as Customer satisfaction-based rating) may refer to ratings processor 215 generating customer satisfaction-based rating, e.g., rating 125, that indicates customer satisfaction towards place of business 110, which may or may not be categorized. The customer satisfaction with place of business 110 may be based on the modified tip index and/or average tip index, with the calculated tip data being commensurate with the particular customer's tipping tendencies; and may be output to an online review site or forum or to an application server for presentation to users or subscribers to service provider 105.

Thus, service provider 105 may produce a customer satisfaction-based rating that is based on transaction information, with the calculated tip data being presumed to be commensurate with a particular customer's tipping tendencies.

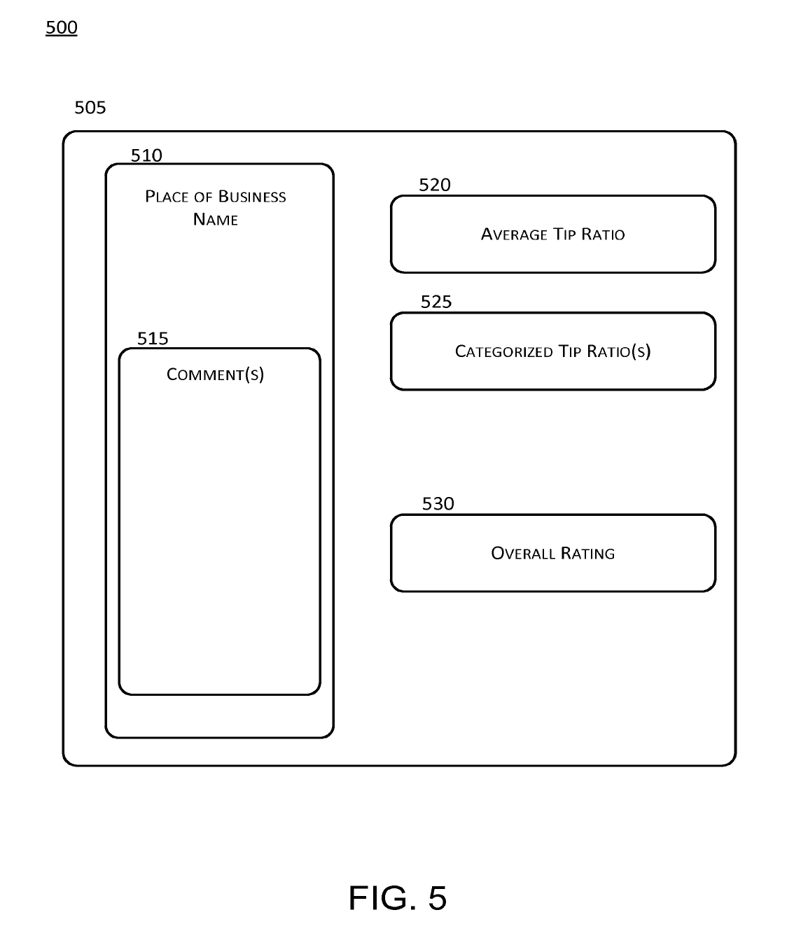

FIG. 5 shows an example ratings interface 505 produced in accordance with at least some embodiments of customer satisfaction-based ratings described herein. Ratings interface 505 may be output to an online review site or forum or output to an application server for presentation to users or subscribers to an application implemented by service provider 105. Although illustrated as discrete components or data fields, various components or data fields of ratings interface 505 may be divided into additional components or data fields, combined into fewer components or data fields, or eliminated altogether while being contemplated within the scope of the disclosed subject matter. In that regard, example ratings interface 505 may include one or more of components or data fields place of business name 510, comment(s) 515, average tip ratio 520, categorized tip ratio(s) 525, and overall rating 530.

Place of business name 510 may refer to a data field in which a name for place of business 110, as the subject of an online review, may be listed.

Comment(s) 515 may refer to a data field in which user comments that accompany transaction information for a respective transaction, as provided to service provider 105, may be displayed as part of a customer or patron's review regarding the respective transaction for an item, service, and/or experience from place of business 110.

Average tip ratio 520 may refer to a data field in which the average tip ratio, calculated for at least the respective transaction by tip calculator 210, may be displayed.

Categorized tip ratio 525 may refer to a data field in which the categorized tip ratio, calculated for at least the respective transaction by tip calculator 210, may be displayed.

Overall rating 530 may refer to a data field in which an overall rating, which may be textual or numerical in nature, may be displayed.

Thus, example rating interface 505 shows just a sampling of data and information that may be displayed in a customer satisfaction-based rating produced by service provider 105, based on transaction information. The embodiment shown in FIG. 5 and described above is in no way limiting, and is provided only for descriptive purposes.

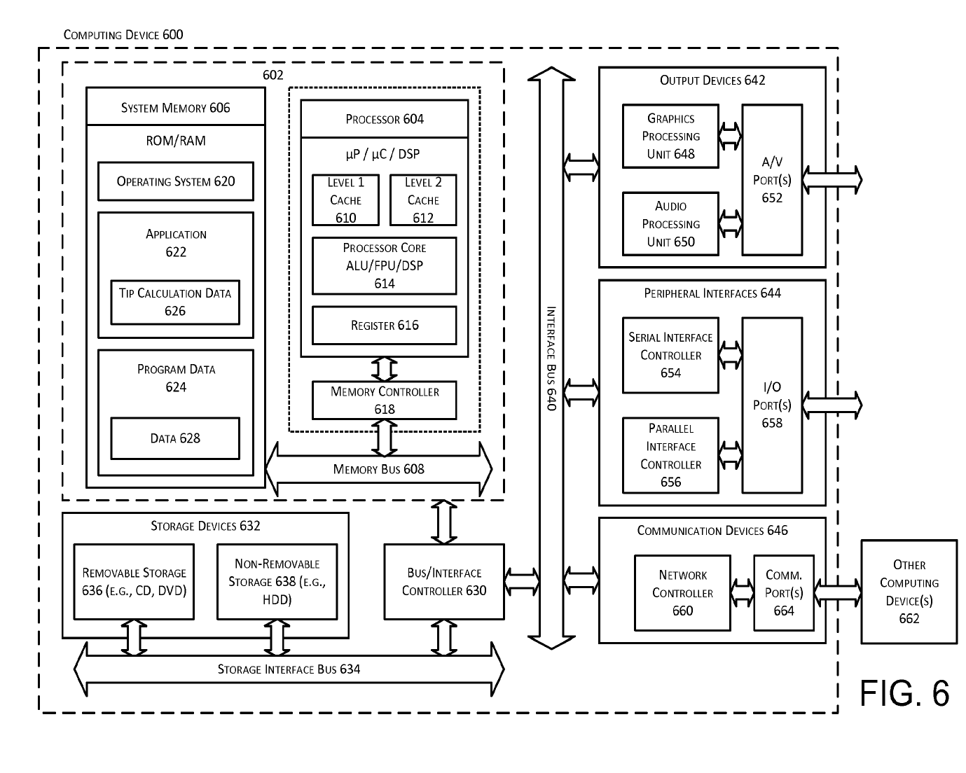

FIG. 6 shows a block diagram illustrating an example computing device 600 by which various example solutions described herein may be implemented, arranged in accordance with at least some embodiments described herein.

In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include tip calculation data 626 that is arranged to perform the functions as described herein including those described with respect to processing flow 300 of FIG. 3, e.g., by tip calculator 210. Program data 624 may include interface data 628 that may be useful for producing interface 405 as described herein. In some embodiments, application 622 may be arranged to operate with program data 624 on operating system 620 such that implementations of customer satisfaction-based ratings may be implemented as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a smartphone, a personal data assistant (PDA), a personal media player device, a wireless web-watch device, a personal headset device, an application specific device, or a hybrid device that include any of the above functions. Computing device 600 may also be implemented as a server or a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for device configuration 300 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium, e.g., a fiber optic cable, a waveguide, a wired communications link, a wireless communication link, etc.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A customer satisfaction-based rating method, comprising:
receiving transaction information from a place of business, the transaction information corresponding to at least one payment made to the place of business, each payment corresponding to a transaction;
for each transaction:
determining, from the received transaction information, a total amount of the payment made to the place of business,
extracting, from the total amount of the payment made to the place of business, an amount tipped, and
calculating a tip ratio based on the extracted amount tipped and the total amount of the payment made to the place of business; and
calculating an average tip ratio based on at least the calculated tip ratio, the average tip ratio to be used as a factor in determining a customer satisfaction-based rating for the place of business.

2. The customer satisfaction-based rating method of claim 1,
wherein the transaction information includes, for each transaction, an amount authorized for the payment and the total amount of the payment made to the place of business, and
wherein the extracting comprises subtracting the amount authorized for the payment from the total amount of the payment made to the place of business.

3. The customer satisfaction-based rating method of claim 1,
wherein the calculating the tip ratio comprises calculating, for the transaction:
the tip ratio=(the amount tipped÷the total amount of the payment)×100, and
wherein the calculating the average tip ratio comprises calculating:
the average tip ratio=(1/N)Σ^{N}ₙ₌₁ tip ratio,
wherein further n is an index register for each transaction.

4. The customer satisfaction-based rating method of claim 1, wherein the calculating of the average tip ratio includes calculating the average tip ratio based on at least the calculated tip ratio for a predetermined time period.

5. A service provider, comprising:
a receiver configured to receive transaction information corresponding to at least one payment made by a customer to a place of business, each payment corresponding to a transaction;
a tip calculator configured to calculate, for at least each transaction, tip data based on the payment made; and
a ratings processor configured to determine a customer satisfaction-based rating for the place of business based on the calculated tip data.

6. The service provider of claim 5, wherein the service provider is a financial institution that manages one or more of a credit card account, a debit card account, or a smart phone payment account for the customer.

7. The service provider of claim 5, wherein the service provider is an application service provider.

8. The service provider of claim 5, wherein the transaction information comprises a receipt.

9. The service provider of claim 5, wherein the tip calculator is further configured to attribute the calculated tip data to the customer.

10. The service provider of claim 5, wherein the calculated tip data includes an amount tipped by the customer, a tip ratio for the customer, and an average tip ratio for the customer.

11. The service provider of claim 10,
wherein the transaction information includes an amount authorized for the payment and a total amount of the payment, and
wherein the tip calculator is configured to calculate the tip data by calculating:
the amount tipped=(the total amount of the payment)−(the amount authorized for the payment), and
the tip ratio=(the amount tipped÷the total amount of the payment)×100.

12. The service provider of claim 11,
wherein the tip calculator is further configured to calculate the tip data for two or more customers by calculating:
the average tip ratio=(1/N)Σ^{N}ₙ₌₁ tip ratio,
wherein further n is an index register for each customer.

13. The service provider of claim 12, wherein the tip calculator is configured to calculate the average tip ratio for one or more transactions over a predetermined time period.

14. The service provider of claim 12, wherein the tip calculator is further configured to categorize at least one of the calculated amount tipped or the calculated tip ratio when the total amount of the payment by any of the customers includes a predetermined service charge.

15. The service provider of claim 12, wherein the tip calculator is further configured to categorize at least one of the calculated amount tipped or the calculated tip ratio based on a time at which a transaction for the total amount of the payment was completed.

16. The service provider of claim 12, wherein the tip calculator is further configured to categorize at least one of the calculated amount tipped or the calculated tip ratio based on a wait-staff associated with the transaction.

17. A non-transitory computer-readable medium that stores executable instructions that, when executed, cause one or more processors to:
receive a receipt regarding a payment made to a place of business;
calculate tip data based on the payment made to the place of business;
categorize the calculated tip data; and
socialize the categorized tip data as a customer satisfaction-based rating for the place of business.

18. The non-transitory computer-readable medium of claim 17, wherein the one or more processors calculate the tip data based on tipping tendencies of a particular customer.

19. The non-transitory computer-readable medium of claim 17, wherein the non-transitory computer-readable medium is hosted on a server corresponding to a financial institution.

20. The non-transitory computer-readable medium of claim 17, wherein the non-transitory computer-readable medium is hosted on a server corresponding to an online service provider.

21. The non-transitory computer-readable medium of claim 17, wherein the receipt is received from a client-based application assigned to a customer of the place of business.

22. The non-transitory computer-readable medium of claim 17, wherein the receipt is received from the place of business.

23. The non-transitory computer-readable medium of claim 17, wherein the instruction to categorize the calculated tip data causes the one or more processors to categorize the calculated tip data for the receipt based on one or more of the payment made, a time at which the payment was made, or a number of customers for which the payment was made.

24. The non-transitory computer-readable medium of claim 17, wherein the instruction to socialize the categorized tip data causes the one or more processors to publish the calculated tip data on one or more online resources.
